(19) United States
(12) Patent Application Publication
(10) Pub. No.: US 2017/0148170 A1
(43) Pub. Date: May 25, 2017

(54) IMAGE PROCESSING METHOD AND APPARATUS

(71) Applicants: Le Holdings (Beijing) Co., Ltd., Beijing (CN); LE SHI ZHI XIN ELECTRONIC TECHNOLOGY (TIANJIN) LIMITED, Beijing (CN)

(72) Inventor: Xiaokun HE, Beijing (CN)

(21) Appl. No.: 15/246,268

(22) Filed: Aug. 24, 2016

Related U.S. Application Data
(63) Continuation of application No. PCT/CN2016/086602, filed on Jun. 21, 2016.

(30) Foreign Application Priority Data
Nov. 24, 2015 (CN) 201510824184.8

(51) Int. Cl. G06T 7/00; G06K 9/62

(52) U.S. Cl. CPC G06T 7/0083; G06T 7/0085; G06K 9/62; G06K 2209/01

(57) ABSTRACT

Image processing methods and apparatus are disclosed. Various illustrative methods may include or involve aspects such as: obtaining an edge feature image of a logo area image; when the edge feature image of the logo area image has a first interval point, removing edge points on the right side of the first interval point; and when the edge feature image of the logo area image has a second interval point, removing edge points below the second interval point. Implementations herein, for example, may be used to process logos having an interval between an icon part and a character part, where the icon part is internally continuous and the character part is generally below or on the right side of the icon part, such that the character part in the logo may be removed quickly and accurately by image processing functionality herein.

### CROSS-REFERENCE TO RELATED APPLICATIONS

This application is a continuation of International PCT patent application No. PCT/CN2016/086602, filed on Jun. 21, 2016 (attached hereto as an Appendix), and claims benefit/priority to Chinese Patent Application No. 2015108241848, filed on Nov. 24, 2015, all of which are incorporated herein by reference in entirety.

### BACKGROUND

Field

The disclosure relates to the technical field of videos, and in particular, to an image processing method and apparatus.

Description of the Related Art

In an actual image processing problem, an edge feature of an image is used as a fundamental feature of the image, and is often applied to the image processing and analysis technology of feature description, image recognition, image segmentation, image enhancement and image compression and the like with higher levels, so as to further analyze and understand the image.

Usually, in the processes of image acquisition, transmission and processing, a variety of noise exists inevitably, and the noise is mixed with a frequency band at the image edge, so that the extracted edge feature image is not accurate enough.

### OVERVIEW OF SOME ASPECTS

Embodiments of the present disclosure provide an image processing method and apparatus, for removing a character part from a TV station logo area image.

On a first aspect, the embodiments of the present disclosure provide an image processing method, including: obtaining an edge feature image of a TV station logo area image; when the edge feature image of the TV station logo area image has a first interval point, removing edge points on the right side of the first interval point; and when the edge feature image of the TV station logo area image has a second interval point, removing edge points below the second interval point; wherein, the first interval point is an edge point in the edge feature image, and the edge point is separated from an adjacent edge point on the right side thereof by more than preset columns of background points; and the second interval point is an edge point in the edge feature image, and the edge point is separated from the adjacent edge point at the lower side thereof by more than preset rows of background points.

On a second aspect, the embodiments of the present disclosure provide an image processing apparatus, including: an edge extraction module, used for obtaining an edge feature image of a TV station logo area image; a first correction module used for, when the edge feature image of the TV station logo area image has a first interval point, removing edge points on the right side of the first interval point; and a second correction module used for, when the edge feature image of the TV station logo area image has a second interval point, removing edge points below the second interval point; wherein, the first interval point is an edge point in the edge feature image, and the edge point is separated from an adjacent edge point on the right side thereof by more than preset columns of background points; and the second interval point is an edge point in the edge feature image, and the edge point is separated from the adjacent edge point at the lower side thereof by more than preset rows of background points.

On an aspect, the embodiments of the present disclosure provide an image processing apparatus, including: one or more processors; a memory; and one or more modules stored in the memory, the one or more modules are configured to perform the following operations when being executed by the one or more processors: obtaining an edge feature image of a TV station logo area image; when the edge feature image of the TV station logo area image has a first interval point, removing edge points on the right side of the first interval point; and when the edge feature image of the TV station logo area image has a second interval point, removing edge points below the second interval point.

Optionally, the first interval point is an edge point in the edge feature image, and the edge point is separated from an adjacent edge point on the right side thereof by more than preset columns of background points; and the second interval point is an edge point in the edge feature image, and the edge point is separated from the adjacent edge point at the lower side thereof by more than preset rows of background points.

Optionally, the processor is further configured to perform the following steps: respectively preprocessing a plurality of images containing the TV station logo area image to obtain the TV station logo area image in each image; and extracting the edge feature from each obtained TV station logo area image respectively, and synthesizing the extracted images to obtain the edge feature image.

Optionally, the processor is further configured to perform the following steps: before removing the edge points on the right side of the first interval point, scanning the edge feature image from left to right to determine whether the edge feature image has the first interval point; and before removing the edge points below the second interval point, scanning the edge feature image from top to bottom to determine whether the edge feature image has the second interval point.

Optionally, the processor is further configured to perform the following steps: obtaining a minimum enclosing rectangle containing the edge points; and only when the length-width ratio of the minimum enclosing rectangle is larger than or equal to a preset length-width ratio, scanning the edge feature image from left to right; scanning the edge feature image within the minimum enclosing rectangle from left to right; and/or, only when the length-width ratio of the minimum enclosing rectangle is larger than or equal to the preset length-width ratio, scanning the edge feature image from top to bottom.

Optionally, the value of the preset length-width ratio is 1.5.

Optionally, the processor is further configured to perform the following steps: obtaining a minimum enclosing rectangle containing the edge points; only scanning the edge feature image within the minimum enclosing rectangle from left to right; and/or, scanning the edge feature image within the minimum enclosing rectangle from top to bottom.

Optionally, wherein, the processor is further configured to perform the following steps: scanning the edge feature image within the minimum enclosing rectangle from left to right with (n/x)^{th} column of pixel points from left to right as the starting column; and/or, scanning the edge feature image within the minimum enclosing rectangle from top to bottom with (m/y)^{th} row of pixel points from top to bottom as the starting row; and wherein, n refers to a total column number of the edge feature image within the minimum enclosing rectangle; m refers to a total row number of the edge feature image within the minimum enclosing rectangle; and x and y are preset values.

Optionally, the x is 6, and the y is 3.

Optionally, wherein, the processor is further configured to perform the following steps: scanning the edge feature image obtained after the edge points on the right side of the first interval point are removed from right to left, and when scanning the first interval point, removing the edge points on the right side of the first interval point; and/or, scanning the edge feature image obtained after the edge points below the second interval point are removed from bottom to top, and when scanning the second interval point, removing the edge points below the second interval point.

On a third aspect, the embodiments of the present disclosure provide an image processing apparatus, including: a processor, a memory, a communication interface and a bus; wherein, the processor, the memory and the communication interface communicate with each other by the bus; the communication interface is used for completing the information transmission of the image processing apparatus and a communication device of an image storage apparatus or an image transmission apparatus; the processor is used for invoking a logic instruction in the memory to execute the following method: obtaining an edge feature image of a TV station logo area image; when the edge feature image of the TV station logo area image has a first interval point, removing edge points on the right side of the first interval point; and when the edge feature image of the TV station logo area image has a second interval point, removing edge points below the second interval point; wherein, the first interval point is an edge point in the edge feature image, and the edge point is separated from an adjacent edge point on the right side thereof by more than preset columns of background points; and the second interval point is an edge point in the edge feature image, and the edge point is separated from the adjacent edge point at the lower side thereof by more than preset rows of background points.

On a fourth aspect, the embodiments of the present disclosure provide a computer program, including a program code, wherein the program code is used for executing the following operations: obtaining an edge feature image of a TV station logo area image; when the edge feature image of the TV station logo area image has a first interval point, removing edge points on the right side of the first interval point; and when the edge feature image of the TV station logo area image has a second interval point, removing edge points below the second interval point; wherein, the first interval point is an edge point in the edge feature image, and the edge point is separated from an adjacent edge point on the right side thereof by more than preset columns of background points; and the second interval point is an edge point in the edge feature image, and the edge point is separated from the adjacent edge point at the lower side thereof by more than preset rows of background points.

For each communication domain in a plurality of marked communication domains, whether the number of edge points of the communication domain is larger than a first preset value is judged; and if not, the edge points of the communication domain are set as the background points.

On a fifth aspect, the embodiments of the present disclosure further provide a storage medium, used for storing the above computer program.

In the image processing method and apparatus provided by the embodiments of the present disclosure, after the edge feature image of the TV station logo area image is obtained, when the edge feature image of the TV station logo area image has the first interval point, edge points on the right side of the first interval point are removed; and when the edge feature image of the TV station logo area image has the second interval point, edge points below the second interval point are removed. In a general TV station logo, there is an interval between an icon part and a character part, the icon part is internally continuous, and the character part is generally below or on the right side of the icon part, so that the character part in the TV station logo can be removed quickly and accurately by the image processing method provided by the embodiments of the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic diagram of a flow of an image processing method provided by an embodiment of the present disclosure;

FIG. 2 is a schematic diagram of a flow of another image processing method provided by an embodiment of the present disclosure;

FIG. 3 illustrates a TV station logo area image before and after the processing of the image processing method provided by an embodiment of the present disclosure;

FIG. 4 is a schematic diagram of a structure of an image processing apparatus provided by an embodiment of the present disclosure;

FIG. 5 is a structural block diagram of another image processing apparatus provided by an embodiment of the present disclosure

### DETAILED DESCRIPTION OF ILLUSTRATIVE IMPLEMENTATIONS

In order that various objective(s), technical solution(s) and/or advantage(s) of the present disclosure are clearer, a clear and complete description of technical solutions in the embodiments of the present disclosure will be given below, in combination with the accompanying drawings in the embodiments of the present disclosure. As apparent to an ordinary artisan, the embodiments described below are merely a part, but not all, of the embodiments of the present inventions/disclosure. Other embodiments, e.g., obtained by those of ordinary skill in the art based on the embodiments of the present disclosure without any creative effort, fall into the protection scope of the present disclosure.

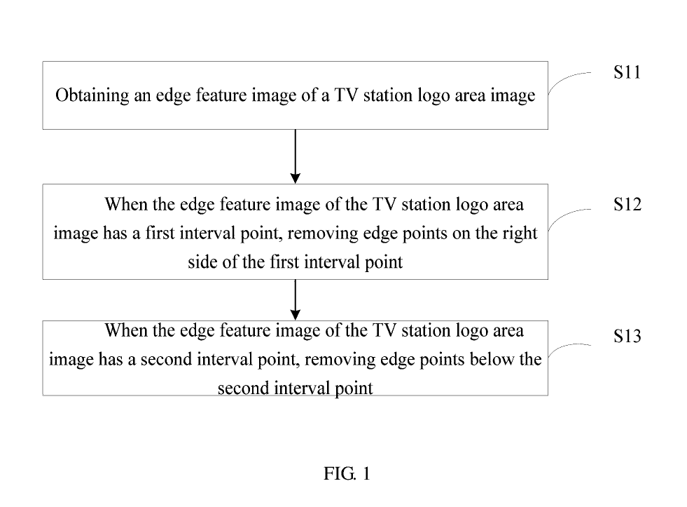

The embodiment of the present disclosure provides an image processing method, and see FIG. 1, the method includes: step S11, obtaining an edge feature image of a TV station logo area image; step S12, when the edge feature image of the TV station logo area image has a first interval point, removing edge points on the right side of the first interval point; and step S13, when the edge feature image of the TV station logo area image has a second interval point, removing edge points below the second interval point; wherein, the first interval point is an edge point in the edge feature image, and the edge point is separated from an adjacent edge point on the right side thereof by more than preset columns of background points; and the second interval point is an edge point in the edge feature image, and the edge point is separated from the adjacent edge point at the lower side thereof by more than preset rows of background points.

In the image processing method provided by the embodiment of the present disclosure, after the edge feature image of the TV station logo area image is obtained, when the edge feature image of the TV station logo area image has the first interval point, edge points on the right side of the first interval point are removed; and when the edge feature image of the TV station logo area image has the second interval point, edge points below the second interval point are removed. In a general TV station logo, there is an interval between an icon part and a character part, the icon part is internally continuous, and the character part is generally below or on the right side of the icon part, so that the character part in the TV station logo can be removed quickly and accurately by the image processing method provided by the embodiment of the present disclosure.

In specific implementation, the step S11 can specifically include the following steps shown in the figure: step S111, respectively preprocessing a plurality of images containing the TV station logo area image to obtain the TV station logo area image in each image; and step S112, extracting the edge feature from each obtained TV station logo area image respectively, and synthesizing the images extracted from the TV station logo area images to obtain the edge feature image.

In this way, the obtained edge feature image can be more accurate, then the first interval point and the second interval point can be accurately obtained in the subsequent process, and thus a corresponding character removal process can be completed accurately.

Specifically, the preprocessing procedure in the step S111 can refer to segmenting an entire television image containing the TV station logo area image to obtain an image of a TV station logo area at the top left corner, and then carrying out graying and gray enhancement on the image to prepare for extracting the edge feature in the step S112.

Specifically, in the above step S112, the edges of the TV station logo area images can be extracted by the Canny algorithm, and strong and weak edge thresholds can be respectively 200 and 50. The process of synthesizing the images extracted from the edges can specifically refer to: for each edge point in a plurality of edge points contained in each image obtained by edge feature extraction, determining whether the occurrence times of the edge point at the same coordinate position in the images is larger than a preset times, and if not, setting the edge point as the background point; and then, merging the residual edge points in the initial edge feature images to obtain the edge feature image of the target image.

In specific implementation, prior to the step S12, the method can further include: scanning the edge feature image from left to right to determine whether the edge feature image has the first interval point.

Prior to the step S13, the method can further include: scanning the edge feature image from top to bottom to determine whether the edge feature image has the second interval point.

Due to this, whether the interval point exists in the corresponding TV station logo can be automatically determined (when the interval point exists, characters exist in general), so as to reduce human intervention. Of course, in actual application, whether the interval point exists can also be manually determined, and the coordinate position of the interval point is input.

Before scanning the edge feature image, the method further includes: obtaining a minimum enclosing rectangle containing the edge points in the edge feature image; and judging whether the length-width ratio of the minimum enclosing rectangle is larger than or equal to a preset length-width ratio; the step S12 specifically includes: only when the length-width ratio of the minimum enclosing rectangle is larger than or equal to the preset length-width ratio, scanning the edge feature image from left to right; and/or, the step S13 specifically includes: only when the length-width ratio of the minimum enclosing rectangle is larger than or equal to the preset length-width ratio, scanning the edge feature image from top to bottom.

In a process of implementing the embodiment of the present disclosure, the inventor finds that the length-width ratio of the minimum enclosing rectangle corresponding to the edge feature image of a TV station logo area image is very small, for example, smaller than 1.5, and then the inventor can basically determine that the TV station logo area image contains no character part. In this way, the first interval point and the second interval point are impossible to exist; and correspondingly, the edge feature image does not need to be scanned at all. In the embodiment of the present disclosure, by means of obtaining the minimum enclosing rectangle containing the edge points in advance, judging whether the length-width ratio of the minimum enclosing rectangle is larger than or equal to the preset length-width ratio, and scanning only when the length-width ratio of the minimum enclosing rectangle is larger than or equal to the preset length-width ratio, so unnecessary scanning can be reduced, and thus, corresponding resource cost is reduced. It is not difficult to understand that, the “length” of the minimum enclosing rectangle herein refers to the length of the minimum enclosing rectangle in the column direction, and specifically can refer to the rows of the contained pixel points; while the “width” refers to the length of the minimum enclosing rectangle in the row direction, and specifically can refer to the columns of the contained pixel points.

It is not difficult to understand that, the minimum enclosing graph containing the edge points herein refers to an enclosing graph of an outline obtained by employing the outline composed of the edge points as the target.

In addition, in specific implementation, in the case of obtaining the minimum enclosing rectangle containing the edge points, in the step S12, only the edge feature image (namely, a binary matrix in the minimum enclosing rectangle) within the minimum enclosing rectangle can be scanned from left to right; and correspondingly, in the step S13, only the edge feature image within the minimum enclosing rectangle can be scanned from top to bottom.

In this way, the area of the edge feature image to be scanned can be reduced, and then the corresponding resource consumption is further reduced.

In specific implementation, the step S12 can specifically include: scanning the edge feature image within the minimum enclosing rectangle from left to right with (n/x)th column of pixel points from left to right as the starting column; and/or, the step S13 can specifically include: scanning the edge feature image within the minimum enclosing rectangle from top to bottom with (m/y)th row of pixel points from top to bottom as the starting row; and wherein, n refers to a total column number of the edge feature image; m refers to a total row number of the edge feature image; and x and y are preset values.

In practical application, the area having no obvious character or icon does not need to be scanned, for example, in the vertical direction, the icon is located above the character, the character is impossible to occur within ⅓ of the height of the area, and thus, the second interval point cannot be scanned in the previous m/3 columns of pixel points generally. In the horizontal direction, four characters may occur, for example, Southeast TV or the like, at this time, the icon only occupies about ⅕ of the width of the TV station logo area image, while Shenzhen TV occupies about ⅙, but the characters are basically impossible to occur at the previous ⅙ width from the left side, then the first interval point cannot be scanned within the previous ⅙ width generally. If the step S12 and the step S13 are executed in the above mode, a scanning leakage condition of the first interval point and the second interval point will not occur, and the number of the pixel points to be scanned is reduced, therefore the scanning time is shortened, the necessary resources are reduced, and the character removal efficiency is improved. In specific implementation, the values of x and y herein can be set according to actual conditions, as an optional mode, the value of x herein can be 6, and the value of y can be 3.

In specific implementation, after the step S13, the method can further include: scanning the edge feature image obtained after the edge points on the right side of the first interval point are removed from right to left, and when scanning the first interval point, removing the edge points on the right side of the first interval point; and correspondingly, after the step S14, the corresponding method can further include: scanning the edge feature image obtained after the edge points below the second interval point are removed from bottom to top, and when scanning the second interval point, removing the edge points below the second interval point.

In this way, the phenomenon that the character part is not removed due to wrong judgment in unidirectional scanning can be avoided.

In specific implementation, the preset row number can be determined according to the total row number of the pixel points of the edge feature image of the TV station logo area image, and correspondingly, the preset column number can be determined according to the total column number of the pixel points of the edge feature image of the TV station logo area image. When the total row number of the pixel points of the edge feature image of the TV station logo area image is 50 and the total column number is 200, the value of the preset row number herein can be 5, and the value of the preset column number can be 7 or 8.

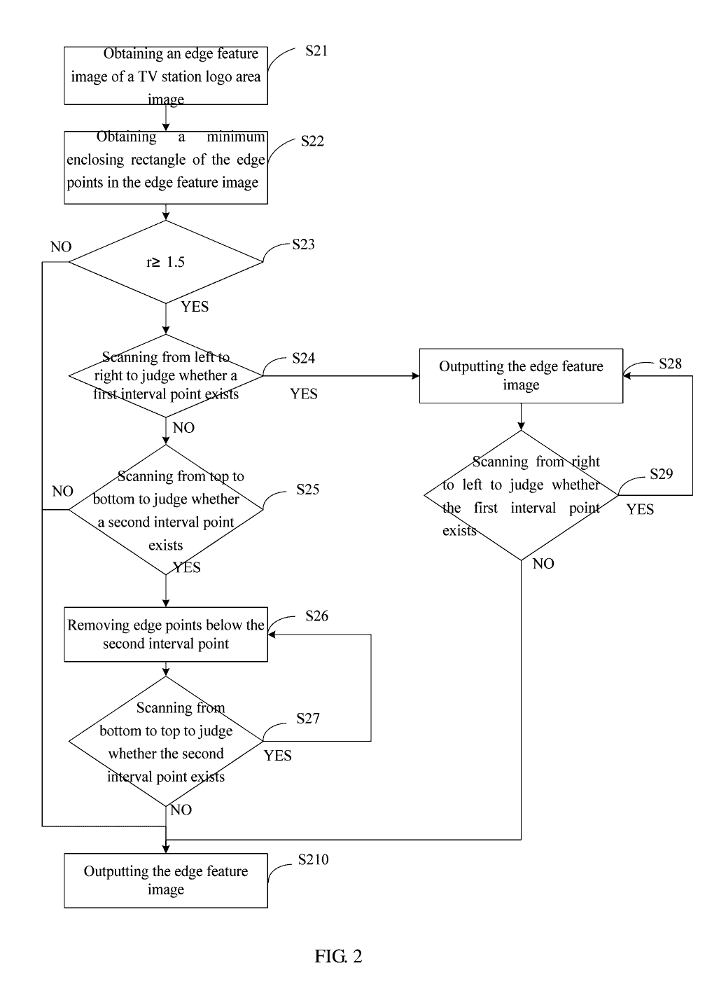

The image processing method provided by the embodiment of the present disclosure will be further illustrated below in combination with a specific application scenario, and see FIG. 2, the method includes: step S21, obtaining an edge feature image of a TV station logo area image; step S22, obtaining a minimum enclosing rectangle of the edge points in the edge feature image; step S23, judging whether the length-width ratio r of the minimum enclosing rectangle is larger than 1.5; if so, turning to a step S24; and otherwise, turning to a step S210; step S24, scanning the edge feature image within the minimum enclosing rectangle from left to right starting from the n/6th column of pixel points on the left side to judge whether a first interval point exists; if so, turning to a step S28; and otherwise, turning to a step S25.

In specific implementation, the pixel points can be scanned column by column, if no edge point is found in the 8 columns of pixels after a column of pixels containing the edge point, it can be determined that the edge point may be the interval point, and if no edge point is found after the column of pixels in the subsequent scanning, the pixel point is not the real first interval point, and if no edge point is found after the column of pixels, the point is deemed as the first interval point.

Step S25, scanning the edge feature image within the minimum enclosing rectangle from top to bottom starting from the (m/3)th row of pixel points at the upper side to judge whether a second interval point exists; if so, turning to a step S26; and otherwise, turning to the step S210.

In specific implementation, the pixel points can be scanned row by row, if no edge point is found in the 5 rows of pixels after a row of pixels containing the edge point, it can be determined that the point may be the interval point, and if no edge point is found after the row of pixels in the subsequent scanning, the pixel point is not the real second interval point, and if no edge point is found after the row of pixels, the point is deemed as the second interval point.

Step S26, removing the edge points below the second interval point, and then, turning to step S27; Step S27, scanning the edge feature image obtained after the edge points are removed from bottom to top to judge whether the second interval point exists; if so, turning to the step S26; and otherwise, turning to the step S210; Step S28, removing the edge points on the right side of the first interval point, and then, turning to a step S29; Step S29, scanning the edge feature image obtained after the edge points are removed from right to left to judge whether the first interval point exists; if so, turning to the step S28; and otherwise, turning to the step S210; and step S210, outputting the edge feature image.

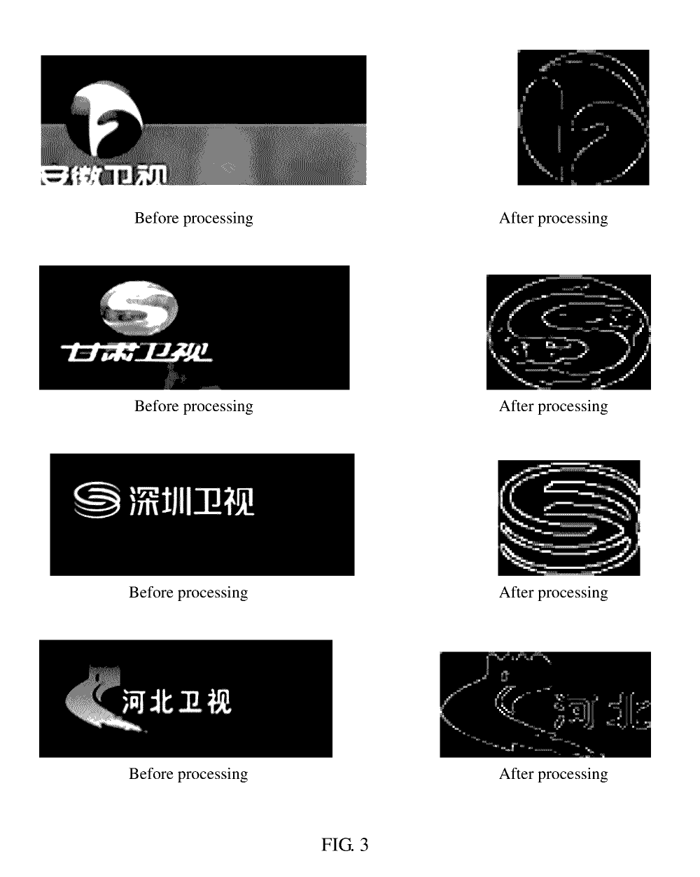

The TV station logo area image before and after the processing of the image processing method provided by the embodiment of the present disclosure can refer to FIG. 3, and the character part in each TV station logo area image herein is removed after the processing.

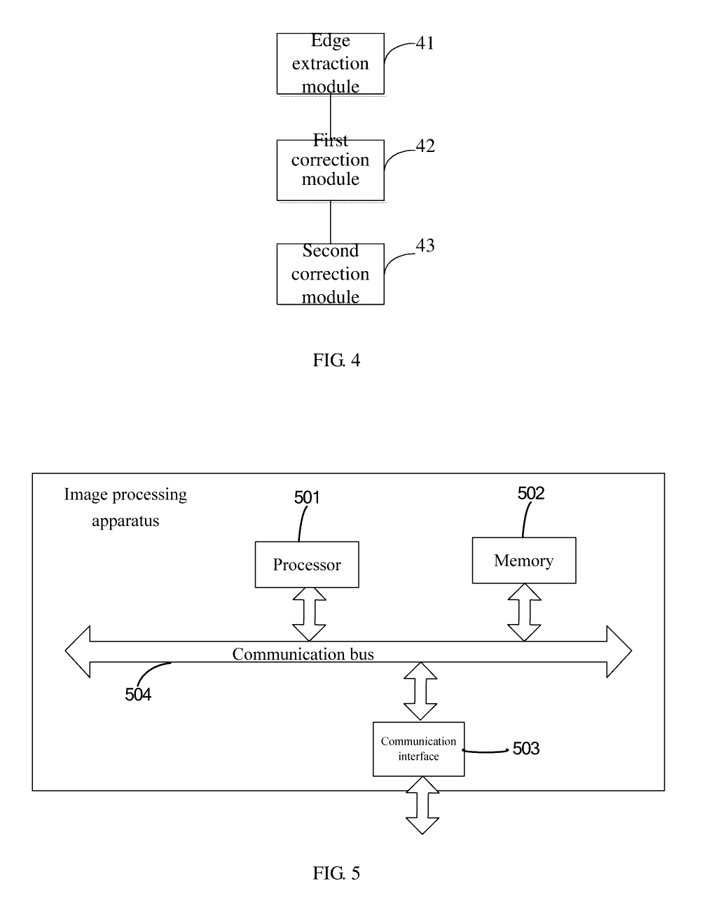

Based on the same concept, another aspect of the embodiment of the present disclosure further provides an image processing apparatus, and see FIG. 4, the apparatus can include: an edge extraction module 41, used for obtaining an edge feature image of a TV station logo area image; a first correction module 42 used for, when the edge feature image of the TV station logo area image has a first interval point, removing edge points on the right side of the first interval point; and a second correction module 43 used for, when the edge feature image of the TV station logo area image has a second interval point, removing edge points below the second interval point; wherein, the first interval point is an edge point in the edge feature image, and the edge point is separated from an adjacent edge point on the right side thereof by more than preset columns of background points; and the second interval point is an edge point in the edge feature image, and the edge point is separated from the adjacent edge point at the lower side thereof by more than preset rows of background points.

Further, the edge extraction module 41 is specifically used for respectively preprocessing a plurality of images containing the TV station logo area image to obtain the TV station logo area image in each image; and extracting the edge feature from each obtained TV station logo area image respectively, and synthesizing the extracted images to obtain the edge feature image.

Further, the first correction module 42 is further used for, before removing the edge points on the right side of the first interval point, scanning the edge feature image from left to right to determine whether the edge feature image has the first interval point; and the second correction module 43 is further used for, before removing the edge points below the second interval point, scanning the edge feature image from top to bottom to determine whether the edge feature image has the second interval point.

Further, the image processing apparatus can further include the following modules not shown in the figure: an obtaining module 44, used for obtaining a minimum enclosing rectangle containing the edge points; and a judging module 45 used for, only when the length-width ratio of the minimum enclosing rectangle is larger than or equal to a preset length-width ratio, scanning the edge feature image from left to right; at this time, the first correction module 41 can be specifically used for scanning the edge feature image within the minimum enclosing rectangle from left to right; and/or, the second correction module is used for, only when the length-width ratio of the minimum enclosing rectangle is larger than or equal to the preset length-width ratio, scanning the edge feature image from top to bottom.

Further, the value of the preset length-width ratio is 1.5.

Further, the first correction module 41 can be specifically used for only scanning the edge feature image within the minimum enclosing rectangle from left to right; and/or, the second correction module 42 can be specifically used for scanning the edge feature image within the minimum enclosing rectangle from top to bottom.

Further, the first correction module 41 is specifically used for scanning the edge feature image within the minimum enclosing rectangle from left to right with (n/x)th column of pixel points from left to right as the starting column; and/or, the second correction module 42 can be specifically used for scanning the edge feature image within the minimum enclosing rectangle from top to bottom with (m/y)th row of pixel points from top to bottom as the starting row; and wherein, n refers to a total column number of the edge feature image within the minimum enclosing rectangle; m refers to a total row number of the edge feature image within the minimum enclosing rectangle; and x and y are preset values.

Further, the x is 6, and the y is 3.

Further, the image processing apparatus can further include the following modules not shown in the figure: a third correction module 46, used for scanning the edge feature image obtained after the edge points on the right side of the first interval point are removed from right to left, and when scanning the first interval point, removing the edge points on the right side of the first interval point; and/or, a fourth correction module 47, used for scanning the edge feature image obtained after the edge points below the second interval point are removed from bottom to top, and when scanning the second interval point, removing the edge points below the second interval point.

The embodiment of the present disclosure further provides a structural block diagram of another image processing apparatus provided by an embodiment of the present disclosure. Refer to FIG. 5, the image processing apparatus includes: a processor (processor) 501, a memory (memory) 502, a communication interface (Communications Interface) 503 and a bus 504; wherein, the processor 501, the memory 502 and the communication interface 503 communicate with each other by the bus 504; the communication interface 503 is used for completing the information transmission of the image processing apparatus and a communication device of an image storage apparatus or an image transmission apparatus; the processor 501 is used for invoking a logic instruction in the memory 502 to execute the following method: obtaining an edge feature image of a TV station logo area image; when the edge feature image of the TV station logo area image has a first interval point, removing edge points on the right side of the first interval point; and when the edge feature image of the TV station logo area image has a second interval point, removing edge points below the second interval point; wherein, the first interval point is an edge point in the edge feature image, and the edge point is separated from an adjacent edge point on the right side thereof by more than preset columns of background points; and the second interval point is an edge point in the edge feature image, and the edge point is separated from the adjacent edge point at the lower side thereof by more than preset rows of background points.

Refer to FIG. 1, the embodiment of the present disclosure further discloses a computer program, including a program code, wherein the program code is used for executing the following operations: obtaining an edge feature image of a TV station logo area image; when the edge feature image of the TV station logo area image has a first interval point, removing edge points on the right side of the first interval point; and when the edge feature image of the TV station logo area image has a second interval point, removing edge points below the second interval point; wherein, the first interval point is an edge point in the edge feature image, and the edge point is separated from an adjacent edge point on the right side thereof by more than preset columns of background points; and the second interval point is an edge point in the edge feature image, and the edge point is separated from the adjacent edge point at the lower side thereof by more than preset rows of background points.

The embodiment of the present disclosure discloses a storage medium, used for storing the above computer program.

Those of ordinary skill in the art can understand that all or a part of the steps in the above method embodiment can be implemented by a program instructing corresponding hardware, the foregoing program can be stored in a computer readable storage medium, and when being executed, the program can execute the steps including the above method embodiment; and the foregoing storage medium includes various media capable of storing program codes, such as a ROM, a RAM, a magnetic disk or an optical disk, etc.

The apparatus embodiment described above is merely exemplary, wherein units described as separate components can be separated physically or not, components displayed as units can be physical units or not, namely, can be located in one place, or can be distributed on a plurality of network units. A part of or all the modules can be selected to achieve the objectives of the technical solutions in the embodiment according to actual demand. Those of ordinary skill in the art can understand and implement them without any creative effort.

By means of the above-mentioned descriptions of the embodiments, those skilled in the art can clearly understand that the embodiments can be implemented by software plus a necessary universal hardware platform, and of course, can be implemented by hardware. Based on this understanding, the technical solutions of the present disclosure or the parts contributing to the prior art can be embodied in the form of a software product, the computer software product can be stored in a computer readable storage medium, such as an ROM/RAM, a magnetic disk, an optical disk or the like, and include several instructions for instructing a computer device (can be a personal computer, a server, or a network system and the like) to execute the method in the embodiments or some parts of the embodiments.

Finally, it should be noted that the above-mentioned embodiments are merely used for illustrating the technical solutions of the embodiments of the present disclosure, rather than limiting them; although the embodiments of the present disclosure have been described in detail with reference to the foregoing embodiments, those of ordinary skill in the art should understand that they could still make modifications to the technical solutions recorded in the foregoing embodiments or make equivalent substitutions to a part of technical features herein; and these modifications or substitutions do not make the essence of the corresponding technical solutions depart from the spirit or scope of the technical solutions of the embodiments of the present disclosure.

1. An image processing method, the method comprising:
obtaining an edge feature image of a TV station logo area image;
when the edge feature image of the TV station logo area image has a first interval point, removing edge points on the right side of the first interval point; and
when the edge feature image of the TV station logo area image has a second interval point, removing edge points below the second interval point;
wherein the first interval point is an edge point in the edge feature image, and the edge point is separated from an adjacent edge point on the right side thereof by more than preset columns of background points; and
wherein the second interval point is an edge point in the edge feature image, and the edge point is separated from the adjacent edge point at the lower side thereof by more than preset rows of background points.

2. The method of claim 1, wherein the obtaining an edge feature image of a TV station logo area image comprises:
respectively preprocessing a plurality of images containing the TV station logo area image to obtain the TV station logo area image in each image; and
extracting the edge feature from each obtained TV station logo area image respectively, and synthesizing the images extracted from the TV station logo area images to obtain the edge feature image.

3. The method of claim 1, wherein before the removing edge points on the right side of the first interval point, the method further comprises:
scanning the edge feature image from left to right to determine whether the edge feature image has the first interval point; and
before removing the edge points below the second interval point, the method further comprises:
scanning the edge feature image from top to bottom to determine whether the edge feature image has the second interval point.

4. The method of claim 3, wherein before scanning the edge feature image, the method further comprises:
obtaining a minimum enclosing rectangle containing the edge points;
judging whether the length-width ratio of the minimum enclosing rectangle is larger than or equal to a preset length-width ratio;
the scanning the edge feature image from left to right specifically comprises:
only when the length-width ratio of the minimum enclosing rectangle is larger than or equal to the preset length-width ratio, scanning the edge feature image from left to right; and/or,
the scanning the edge feature image from top to bottom specifically comprises:
only when the length-width ratio of the minimum enclosing rectangle is larger than or equal to the preset length-width ratio, scanning the edge feature image from top to bottom.

5. The method of claim 4, wherein the value of the preset length-width ratio is 1.5.

6. The method of claim 3, wherein before scanning the edge feature image, the method further comprises:
obtaining a minimum enclosing rectangle containing the edge points;
the scanning the edge feature image from left to right specifically comprises:
only scanning the edge feature image within the minimum enclosing rectangle from left to right; and/or,
the scanning the edge feature image from top to bottom specifically comprises:
only scanning the edge feature image within the minimum enclosing rectangle from top to bottom.

7. The method of claim 6, wherein,
the scanning the edge feature image within the minimum enclosing rectangle from left to right specifically comprises: scanning the edge feature image within the minimum enclosing rectangle from left to right with (n/x)th column of pixel points from left to right as the starting column; and/or,
the scanning the edge feature image from top to bottom comprises:
scanning the edge feature image within the minimum enclosing rectangle from top to bottom with (m/y)th row of pixel points from top to bottom as the starting row; and
wherein, n refers to a total column number of the edge feature image within the minimum enclosing rectangle; m refers to a total row number of the edge feature image within the minimum enclosing rectangle; and x and y are preset values.

8. The method of claim 7, wherein the x is 6, and the y is 3.

9. The method of claim 3, further comprising:
scanning the edge feature image obtained after the edge points on the right side of the first interval point are removed from right to left, and when scanning the first interval point, removing the edge points on the right side of the first interval point; and/or,
scanning the edge feature image obtained after the edge points below the second interval point are removed from bottom to top, and when scanning the second interval point, removing the edge points below the second interval point.

10. An image processing apparatus, comprising:
one or more processors; a memory; and one or more modules stored in the memory, the one or more modules are configured to perform the following operations when being executed by the one or more processors:
obtaining an edge feature image of a TV station logo area image;
when the edge feature image of the TV station logo area image has a first interval point, removing edge points on the right side of the first interval point; and
when the edge feature image of the TV station logo area image has a second interval point, removing edge points below the second interval point;
wherein, the first interval point is an edge point in the edge feature image, and the edge point is separated from an adjacent edge point on the right side thereof by more than preset columns of background points; and
the second interval point is an edge point in the edge feature image, and the edge point is separated from the adjacent edge point at the lower side thereof by more than preset rows of background points.

11. The apparatus of claim 10, wherein the processor is further configured to perform the following steps: respectively preprocessing a plurality of images containing the TV station logo area image to obtain the TV station logo area image in each image; and
extracting the edge feature from each obtained TV station logo area image respectively, and synthesizing the extracted images to obtain the edge feature image.

12. The apparatus of claim 10, wherein, the processor is further configured to perform the following steps:
before removing the edge points on the right side of the first interval point, scanning the edge feature image from left to right to determine whether the edge feature image has the first interval point; and
before removing the edge points below the second interval point, scanning the edge feature image from top to bottom to determine whether the edge feature image has the second interval point.

13. The apparatus of claim 12, wherein the processor is further configured to perform the following steps:
obtaining a minimum enclosing rectangle containing the edge points; and
only when the length-width ratio of the minimum enclosing rectangle is larger than or equal to a preset length-width ratio, scanning the edge feature image from left to right;
scanning the edge feature image within the minimum enclosing rectangle from left to right; and/or,
only when the length-width ratio of the minimum enclosing rectangle is larger than or equal to the preset length-width ratio, scanning the edge feature image from top to bottom.

14. The apparatus of claim 13, wherein the value of the preset length-width ratio is 1.5.

15. The apparatus of claim 12, the processor is further configured to perform the following steps:
obtaining a minimum enclosing rectangle containing the edge points;
only scanning the edge feature image within the minimum enclosing rectangle from left to right; and/or,
scanning the edge feature image within the minimum enclosing rectangle from top to bottom.

16. The apparatus of claim 15, wherein, the processor is further configured to perform the following steps:
scanning the edge feature image within the minimum enclosing rectangle from left to right with (n/x)th column of pixel points from left to right as the starting column; and/or, scanning the edge feature image within the minimum enclosing rectangle from top to bottom with (m/y)th row of pixel points from top to bottom as the starting row; and
wherein, n refers to a total column number of the edge feature image within the minimum enclosing rectangle; m refers to a total row number of the edge feature image within the minimum enclosing rectangle; and x and y are preset values.

17. The apparatus of claim 16, wherein the x is 6, and the y is 3.

18. The apparatus of claim 11, wherein, the processor is further configured to perform the following steps:
scanning the edge feature image obtained after the edge points on the right side of the first interval point are removed from right to left, and when scanning the first interval point, removing the edge points on the right side of the first interval point; and/or,
scanning the edge feature image obtained after the edge points below the second interval point are removed from bottom to top, and when scanning the second interval point, removing the edge points below the second interval point.

19. An image processing apparatus, comprising:
a processor, a memory, a communication interface and a bus; wherein,
the processor, the memory and the communication interface communicate with each other by the bus;
the communication interface is used for completing the information transmission of the image processing apparatus and a communication device of an image storage apparatus or an image transmission apparatus;
the processor is used for invoking a logic instruction in the memory to execute the following method:
obtaining an edge feature image of a TV station logo area image;
when the edge feature image of the TV station logo area image has a first interval point, removing edge points on the right side of the first interval point; and
when the edge feature image of the TV station logo area image has a second interval point, removing edge points below the second interval point;
wherein, the first interval point is an edge point in the edge feature image, and the edge point is separated from an adjacent edge point on the right side thereof by more than preset columns of background points; and
the second interval point is an edge point in the edge feature image, and the edge point is separated from the adjacent edge point at the lower side thereof by more than preset rows of background points.

20. (canceled)

21. The method of claim 7, further comprising:
scanning the edge feature image obtained after the edge points on the right side of the first interval point are removed from right to left, and when scanning the first interval point, removing the edge points on the right side of the first interval point; and/or,
scanning the edge feature image obtained after the edge points below the second interval point are removed from bottom to top, and when scanning the second interval point, removing the edge points below the second interval point.
